(19) United States
(12) Patent Application Publication
(10) Pub. No.: US 2008/0043207 A1
(43) Pub. Date: Feb. 21, 2008

(54) PROJECTION APPARATUS

(75) Inventors: Min-Xuan Chang, Hsinchu (TW); Chien-Chung Liao, Hsinchu (TW); Min-Tun Lin, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/767,531

(22) Filed: Jun. 25, 2007

(30) Foreign Application Priority Data
Aug. 15, 2006 (TW) 95129852

(51) Int. Cl. G03B 21/14

(52) U.S. Cl. 353/85

(57) ABSTRACT

A projection apparatus includes a projection module and a user operation interface including a button module and a sensor module. The button module includes a button and a light source located under the button. The sensor module is electrically connected to the button module and the sensor module has a sensing scope. The sensing scope covers a location above the button module. When hands of user approach the button module and enter the sensing scope above the button module, the light source under the button provides sufficient illumination, such that users can identify the location of the button easily in dark environment.

### CROSS-REFERENCE TO RELATED APPLICATION

This application claims the priority benefit of Taiwan application Ser. No. 95129852, filed Aug. 15, 2006. All disclosure of the Taiwan application is incorporated herein by reference.

### BACKGROUND OF THE INVENTION

1. Field of the Invention

The present invention relates to a user operation interface, and more particularly, to a user operation interface of projectors.

2. Description of Related Art

In modern society, the projector is widely used in education, presentation and meetings, it even becomes an important tool for providing the video image in home entertainment. In order to project images with better contrast ratio, projectors are usually operated in dark environment. In prior art projector, light source is disposed under buttons of the user operation interface such that users can easily identify the location of the buttons even though the projector is operated in dark environment. However, the light source disposed under the user operation interface may not always be turned on. For example, after users clicking the buttons, the light source may be turned on during a predetermined period. After the predetermined period, the light source may be turned off automatically if users do not click the buttons again for power saving purpose. When the light source is turned off, users can not identify the location of the button in dark environment, which results in that the location of buttons is not easy to find and user may click wrong buttons. Therefore, it is an important issue to help users using the projector correctly in dark environment.

### SUMMARY OF THE INVENTION

The present invention is directed to provide a projector that users can use the projector correctly in dark environment.

As embodied and broadly described herein, an embodiment of the present invention provides a user operation interface including a button module and a sensor module. The button module includes a button and a light source disposed under the button. The sensor module is electrically connected to the button module, wherein the sensor module has a sensing scope that covers a location above the button module.

As embodied and broadly described herein, an embodiment of the present invention provides a projector including a projection module and the above-mentioned user operation interface. The projection module is suitable for projecting an image on a screen. The user operation interface is disposed on and electrically connected to the projection module.

Since adding a sensor module, the projector can be used by users in dark environment without an inconvenience. When the projector is operated in dark environment and hands of users approach the sensing scope of the sensor module, the hands of users is sensed by the sensor module. Meanwhile, the light source disposed under the buttons is turned on to provide sufficient illumination. Therefore, the users can easily operate the projector in dark environment.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view schematically illustrating an user operation interface of an embodiment in the present invention.

FIG. 1B is a side view schematically illustrating an user operation interface of an embodiment in the present invention.

FIG. 2 is a block diagram schematically illustrating a projector of an embodiment in the present invention.

FIG. 3A is a block diagram schematically illustrating the sensor module according to an embodiment of the present invention.

FIG. 3B is a block diagram schematically illustrating the sensor module according to another embodiment of the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “under,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and variations thereof herein are used broadly and encompass direct and indirect connections. Similarly, “adjacent to” and variations thereof herein are used broadly and encompass directly and indirectly “adjacent to”. Therefore, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive. Reference will now be made in detail to the present preferred embodiments of the invention, examples of which are illustrated in the accompanying drawings. Wherever possible, the same reference numbers are used in the drawings and the description to refer to the same or like parts.

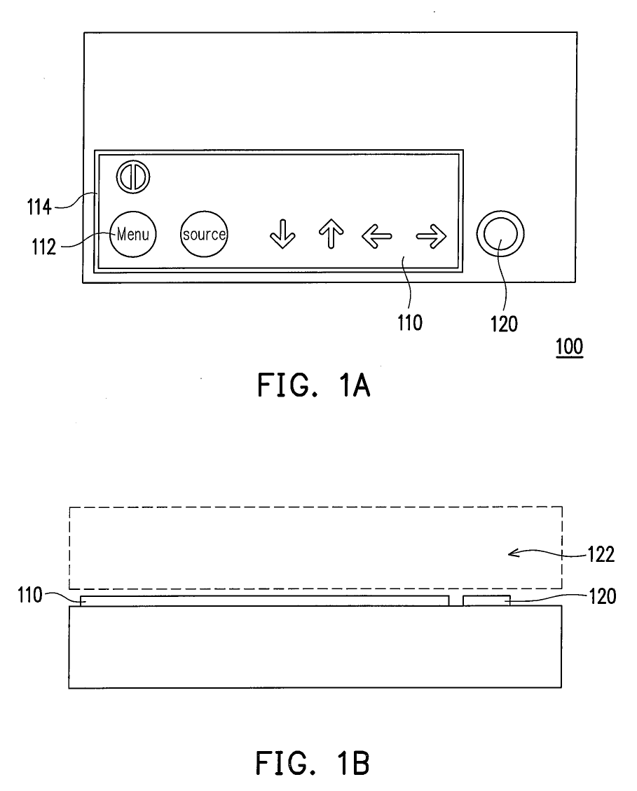

Referring to FIG. 1A and FIG. 1B, a user operation interface 100 of the embodiment includes a button module 110 and a sensor module 120. The button module 110 includes at least a button 112 and a light source 114 disposed under the button 112. The sensor module 120 is electrically connected to the button module 110 so as to turn on or turn off the light source 114 of the button module 110. The sensor module 120 has a sensing scope 122 that covers a location above the button module 110. Moreover, in this embodiment, the sensor module 120 of the user operation interface 100 is disposed adjacent to the button module 110. In an alternative embodiment, the sensor module 120 of the user operation interface 100 may be disposed within the button module 110.

In a preferred embodiment of the present invention, the sensing scope 122 of the sensor module 120 may be distributed to cover all the buttons 112 of the button module 110, such that the light source 114 is turned on when users approach any one of the buttons 112. In this way, users can easily identify the precise locations of the buttons 112. In another preferred embodiment of the present invention, the sensing scope 122 of the sensor module 120 may be distributed to cover all the buttons 112 of the button module 110 and an area outside the button module 110, such that users can identify the precise locations of the buttons 112 more rapidly.

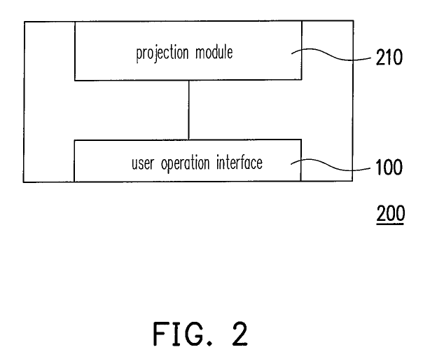

FIG. 2 is a block diagram schematically illustrating a projector of an embodiment in the present invention. As shown in FIG. 2, the projector 200 of the embodiment includes a projection module 200 and the user operation interface 100 illustrated in FIG. 1A and FIG. 1B. The user operation interface 100 is disposed on and electrically connected to the projection module 210. When the projector 200 is used by users, users can control the projector 200 to project images on a screen through the user operation interface 100.

During operation of the projector 200, users may want to adjust, pause or stop, the projector 200 due to some unexpected or special conditions. At this time, users may control the projector 200 through the user operation interface 100 again. However, users can not clearly identify the buttons 112 of the user operation interface 100 without sufficient illumination, since the projector 200 is operated in dark environment. In this embodiment, when the projector 200 is operated in dark environment and hands of users approach the sensing scope 122 of the sensor module 120, the light source 114 disposed under the buttons 112 is immediately turned on to provide sufficient illumination for the buttons 112. Therefore, the users can easily identify location of the buttons 112 and correctly operate the projector 200. In other words, when the hands of the users are sensed by the sensor module 120 having the sensing scope 122, the light source 114 disposed under the buttons 112 can be turned on immediately such that users can operate the projector 200 correctly.

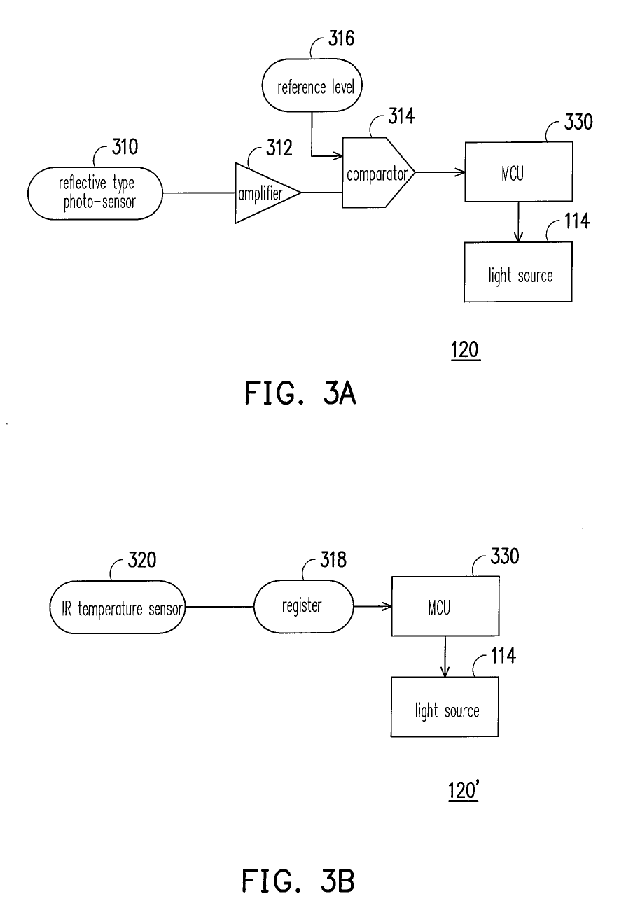

As described above, the sensor module 120 of the embodiment may be a reflective type photo-sensor 310 or an IR temperature sensor 320, for example. FIG. 3A and 3B are respectively block diagrams schematically illustrating the sensor modules according to embodiments of the present invention. Referring to FIG. 3A and 3B, environment variation is respectively detected by the reflective type photo-sensor 310 or IR temperature sensor 320. The detected result is processed through a micro controller unit (MCU) 330 to turn on the light source 114. Referring to FIG. 3A, the sensor module 120 according to this embodiment comprises a reflective type photo-sensor 310, an amplifier 312, a comparator 314, a MCU 330, and a light source 114. The reflective type photo-sensor 310 is capable of emitting a light beam. When the light beam is reflected back to the reflective type photo-sensor 310 by the hands of the users, the reflective type photo-sensor 310 provides a signal to an amplifier 312. The amplitude of the signal provided from the reflective type photo-sensor 310 is gained through the amplifier 312 and than the signal to be compared with a reference level 316 through a comparator 314. Thereafter, the light source 114 is turned on through the MCU 330. On the other hand, referring to FIG. 3B, the sensor module 120′ according to this embodiment comprises an IR temperature sensor 320, a register 318, a MCU 330, and a light source 114. The heat emitted from users is detected by the IR temperature sensor 320, and then a temperature data is generated by the IR temperature sensor 320 and recorded in a register 318 of the IR temperature sensor 320. The MCU 330 reads and analyzes the temperature data recorded in a register 318 to judge whether users approach the projector 200. The MCU 330 turns on the light source 114 according to the analysis result to provide sufficient illumination.

Except for the reflective type photo-sensor 310 or the IR temperature sensor 320, other types of sensor module 114 may also be used in the present invention. The light source 114 disposed under the button 112 may be a light emitting diode (LED), a lamp, or other illumination devices. Additionally, the buttons 112 of the button module 110 may be click buttons or touch buttons.

It is noted that the user operation interface 100 used in the projector 200 of this embodiment is merely described for illustration, the user operation interface 100 of the present invention may applied to other apparatuses working in dark environment.

Sine a sensor module is utilized in the user operation interface, the projector of the present invention can be used by users in dark environment without any inconvenient. When the projector is operated in dark environment and hands of users approach the sensing scope of the button module, the hands of the users is sensed by the sensor module. At this time point, the light source disposed under the buttons is turned on to provide sufficient illumination. Therefore, the users can easily operate the projector in dark environment.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector, comprising:
a projection module for projecting an image on a screen; and
a user operation interface disposed on and electrically connected to the projection module, wherein users control the projection module to project the image on the screen through the user operation interface, the user operation interface comprises:
a button module including a button and a light source disposed under the button;
a sensor module electrically connected to the button module so as to turn on or turn off the light source, and the sensor module having a sensing scope that covers a location above the button module.

2. The projector of claim 1, wherein the sensor module is disposed adjacent to the button module.

3. The projector of claim 1, wherein the sensor module is disposed within the button module.

4. The projector of claim 1, wherein the sensor module comprises a reflective type photo-sensor.

5. The projector of claim 4, wherein the reflective type photo-sensor emits a light beam, when the light beam is reflected back to the reflective type photo-sensor by the users, the reflective type photo-sensor provides a signal to a comparator so as to compared with a reference level, and thereafter, the light source is turned on through a micro controller unit.

6. The projector of claim 1, wherein the sensor module comprises an infrared radiation temperature sensor.

7. The projector of claim 6, wherein the infrared radiation temperature sensor detects environment variation and the light source is turned on through a micro controller unit.

8. The projector of claim 6, wherein the button of the button module is a click button or a touch button.
